(19) United States
(12) Patent Application Publication
(10) Pub. No.: US 2022/0230065 A1
(43) Pub. Date: Jul. 21, 2022

(54) SEMI-SUPERVISED TRAINING OF MACHINE LEARNING MODELS USING LABEL GUESSING

(71) Applicant: Google LLC, Mountain View, CA (US)

(72) Inventor: David BERTHELOT, Mountain View, CA (US)

(21) Appl. No.: 17/609,548

(22) PCT Filed: May 6, 2020
(86) PCT No.: PCT/US2020/031691

§ 371 Date: Nov. 8, 2021

Related U.S. Application Data
(60) Provisional application No. 62/843,806, filed on May 6, 2019.

(51) Int. Cl. G06N 3/08

(52) U.S. Cl. CPC G06N 3/08

(57) ABSTRACT

Methods, systems, and apparatus, including computer programs encoded on computer storage media, for training a machine learning model. One of the methods includes receiving an unlabeled batch; receiving a labeled batch; generating, from the unlabeled batch and the labeled batch, a processed unlabeled batch and a processed labeled batch, the generating comprising: for each unlabeled training input of the plurality of unlabeled training inputs: generating, from the unlabeled training input, a plurality of augmented unlabeled training inputs; processing each of the augmented unlabeled training inputs using the machine learning model to generate a respective model output for each augmented unlabeled training input; generating, from the model outputs for the augmented unlabeled training inputs, a guessed model output; and associating the guessed model output with each of the augmented unlabeled training inputs; and training the machine learning model on the processed labeled batch and the processed unlabeled batch.

### CROSS-REFERENCE TO RELATED APPLICATION

This application claims priority to U.S. Provisional Patent Application No. 62/843,806, filed May 6, 2019, the entirety of which is herein incorporated by reference.

### BACKGROUND

This specification relates to training machine learning models.

Machine learning models receive an input and generate an output, e.g., a predicted output, based on the received input and on values of the parameters of the model.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that trains a machine learning model to perform a machine learning task through semi-supervised learning, i.e., by training the machine learning model on training data that includes unlabeled training inputs and labeled training inputs. A labeled training input is an input for which a ground truth output, i.e., the output that should be generated by the machine learning model by performing the particular machine learning task on the labeled training input, is available. An unlabeled training input is a training input for which the ground truth output is not available.

The system trains the machine learning model by, in part, generating guessed model outputs for the unlabeled training inputs in the training data. To generate a guessed model outputs, the system generates, from the unlabeled training input, a plurality of augmented unlabeled training inputs. The system then processes the plurality of augmented unlabeled training inputs using the machine learning model to generate a respective model output for each of the augmented unlabeled training inputs. The system then generates the guessed model output from the respective model outputs for each of the augmented unlabeled training inputs.

Particular embodiments of the subject matter described in this specification can be implemented so as to realize one or more of the following advantages.

The described systems can train machine learning models to perform well on machine learning tasks with limited labeled data. In particular, by making use of “label guessing,” i.e., generated guessed model outputs for unlabeled training inputs, the described systems can train a machine learning model to have high performance with a lower ratio of labeled data to unlabeled data as compared to conventional techniques. Given the same amount of labeled data and unlabeled data, the system can train a machine learning model to have better accuracy as compared to using a conventional technique. As a particular example, the described techniques can be used to train a machine learning model to achieve state of the art performance on a variety of image classification tasks.

Additionally, the system can train the machine learning model to be robust to input variability, e.g., to effectively handle variability in inputs. For example, a trained machine learning model that has been trained according to the described techniques will be able to effectively classify input images even when images have occlusions or blurriness, have varying degrees of skew, varying degrees of rotation, and so on.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example machine learning model training system.

FIG. 2 is a flow diagram of an example process for training a machine learning model.

FIG. 3A is a flow diagram of an example process for training a machine learning model on a batch of unlabeled training inputs and a batch of labeled training inputs.

FIG. 3B is a diagram showing the generation of an initial processed unlabeled batch.

FIG. 4 shows the performance of the described techniques relative to other semi-supervised learning techniques.

Like reference numbers and designations in the various drawings indicate like elements.

### DETAILED DESCRIPTION

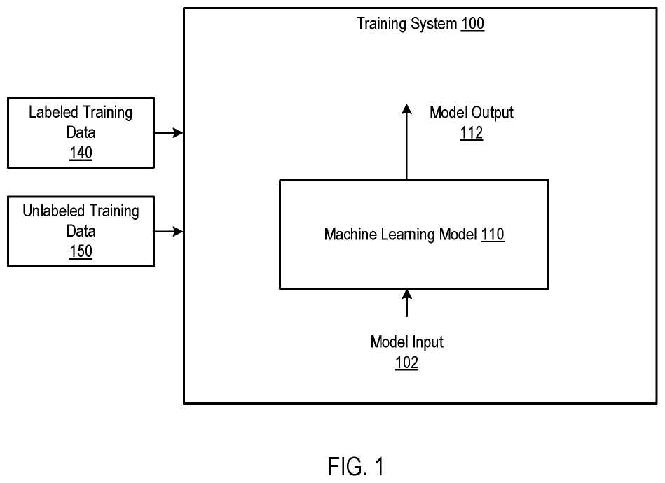

FIG. 1 shows an example machine learning model training system 100. The machine learning model training system 100 is an example of a system implemented as computer programs on one or more computers in one or more locations, in which the systems, components, and techniques described below can be implemented.

The machine learning model training system 100 is a system that trains a machine learning model 110 on training data that includes labeled training data 140 and unlabeled training data 150 to determine trained values of the parameters of the machine learning model 110, referred to in this specification as model parameters, from initial values of the model parameters.

The machine learning model 110 is a machine learning model that is configured to receive a model input 102 and to process the model input to map the model input 102 to a model output 112 to perform a particular machine learning task in accordance with the model parameters.

The machine learning model 110 can be configured to perform any of a variety of machine learning tasks, i.e., to receive as input any kind of digital data input and to generate a model output from the input. Generally, the model output is a probability distribution over a set of possible classes.

For example, if the task is image classification, the inputs to the model 110 are images and the model output for a given image may be probabilities for each of a set of object categories, with each probability representing an estimated likelihood that the image contains an image of an object belonging to the category.

For example, if the task is video classification, the inputs to the model 110 are one or more video frames and the model output is a probability distribution over a set of object classes or a probability distribution over a set of topics.

As another example, if the machine learning task is document classification, the inputs to the machine learning model 110 are text from Internet resources (e.g., web pages) or documents and the model output for a given Internet resource, document, or portion of a document may be a score for each of a set of topics, with each score representing an estimated likelihood that the Internet resource, document, or document portion is about the topic.

As another example, if the task is a natural language understanding task, the inputs to the machine learning model 110 are sequences of text and the model output for a given sequence of text can be a probability distributions that is appropriate for the natural language understanding task, e.g., a distribution over language acceptability categories, language sentiment categories, language paraphrasing categories, sentence similarity categories, textual entailment categories, question answering categories, and so on.

As another example, if the task is a health prediction task, the inputs to the machine learning model 110 are electronic health record data for a patient, and the model output for a given sequence can be a probability distribution over patient health-related categories, e.g., possible diagnoses for the patient, possible future health events associated with the patient, and so on.

As another example, if the task is a speech processing task, the inputs to the machine learning model 110 can be an audio signal, i.e., audio data, representing a spoken utterance, e.g., raw audio or acoustic features, and the model output can be a probability distribution over a set of speech classification categories, e.g., a probability distribution over possible languages, a probability distribution over a set of natural language text, e.g., possible hotwords, and so on.

The machine learning model 110 can have any architecture that is appropriate for the type of model inputs processed by the machine learning model 110. For example, when the model inputs are images or audio data, the machine learning model 110 can be a convolutional neural network. When the model inputs are text sequences or sequences of other features, e.g., electronic health record features or audio features, the machine learning model 110 can be a self-attention based neural network, e.g., a Transformer, or a recurrent neural network, e.g., a long short-term memory (LSTM) neural network. When the model inputs include inputs of multiple modalities, e.g., both images and text, the model 110 can include different types of neural networks, e.g., both convolutional layers and self-attention or recurrent layers.

The labeled training data 140 that is used by the system 100 to train the machine learning model 110 includes multiple batches of labeled training inputs. The training inputs are referred to as “labeled” training inputs because the labeled training data 140 also includes, for each labeled training input, a ground truth output, i.e., an output that should be generated by the machine learning model by performing the particular machine learning task on the labeled training input. In other words, the ground truth output is the actual output of the machine learning task when performed on the corresponding labeled training input.

The unlabeled training data 150 that is used by the system 100 to train the machine learning model 110 includes multiple batches of unlabeled training inputs. The training inputs are referred to as “unlabeled” training inputs because ground truth outputs for the unlabeled training inputs are unavailable, i.e., the system 100 does not have access to any ground truth outputs for any of the unlabeled training inputs or for some other reason cannot use ground truth outputs for any of the unlabeled training inputs for the training of the model 110.

Generally, the system 100 trains the machine learning model 110 by performing an iterative training process.

At each iteration of the training process, the system 100 trains the model 110 on a batch of unlabeled training data and a batch of labeled training data. To train the model 110 on these two batches at any given training iteration, the system 100 generates a processed batch of labeled data and a processed batch of unlabeled data and then trains the machine learning model on the processed labeled batch and the processed unlabeled batch to adjust the current values of the model parameters, i.e., the values of the model parameters as of the training iteration.

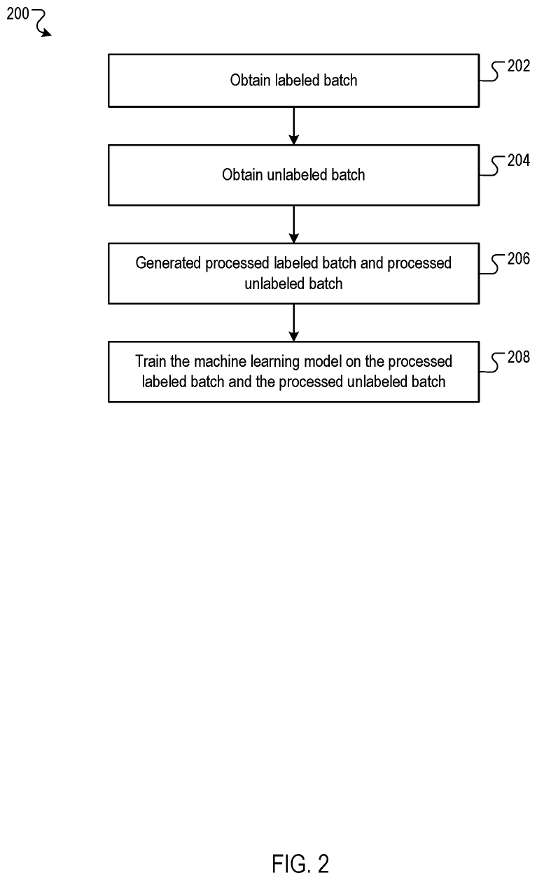

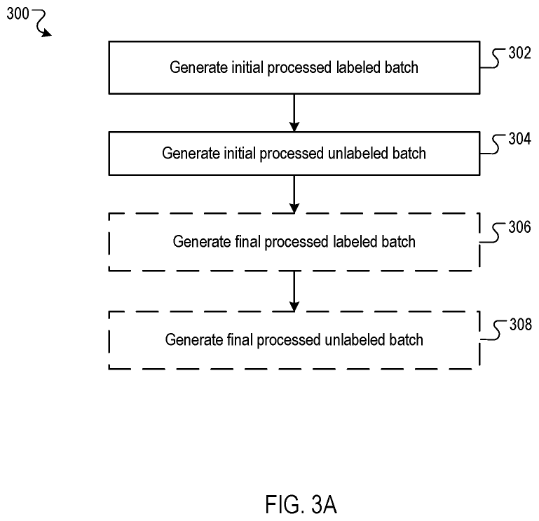

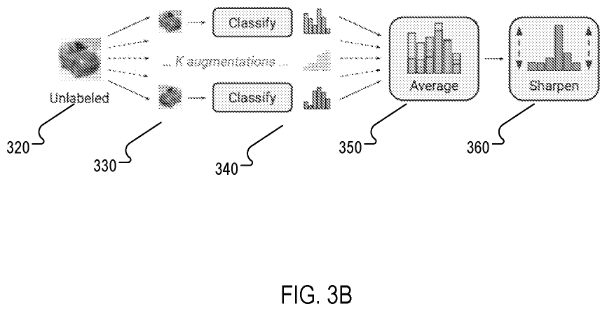

Performing a training iteration during the training of the model 110 is described in more detail below with reference to FIGS. 2, 3A, and 3B.

Once the model 110 has been trained, the system 100 can provide data specifying the trained model for use in processing new network inputs. That is, the system 100 can output, e.g., by outputting to a user device or by storing in a memory accessible to the system 100, the trained values of the model parameters for later use in processing inputs using the trained model.

Alternatively or in addition to outputting the trained model data, the system 100 can instantiate an instance of the machine learning model having the trained values of the model parameters, receive inputs to be processed, e.g., through an application programming interface (API) offered by the system, use the trained model to process the received inputs to generate model outputs and then provide the generated model outputs, classification outputs, or both in response to the received inputs.

FIG. 2 is a flow diagram of an example process 200 for training a machine learning model on a batch of unlabeled training inputs and a batch of labeled training inputs. For convenience, the process 200 will be described as being performed by a system of one or more computers located in one or more locations. For example, a machine learning model training system, e.g., the machine learning model training system 100 of FIG. 1, appropriately programmed, can perform the process 200.

The system can perform the process 200 multiple times for multiple different labeled batch-unlabeled batch combinations to determine trained values of the model parameters from initial values of the model parameters, i.e., can perform the process 200 repeatedly at different training iterations of an iterative training process to train the machine learning model. For example, the system can continue performing the process 200 for a specified number of iterations, for a specified amount of time, or until the change in the values of the parameters falls below a threshold.

The system obtains a labeled batch, i.e., a batch of labeled training inputs and, for each labeled training input, a ground truth output that should be generated by the machine learning model by performing the particular machine learning task on the labeled training input (step 202).

The system obtains an unlabeled batch, i.e., a batch of unlabeled training inputs (step 204).

The system generates, from the unlabeled batch and the labeled batch, a processed unlabeled batch and a processed labeled batch (step 206).

After the processed labeled batch and the processed unlabeled batch are generated, each input in the processed labeled batch and each input in the processed unlabeled batch is associated with a respective target model output.

Generally, and as will be described in more detail below, each input in the processed labeled batch corresponds to a respective one of the labeled training inputs and the target output for the input either (i) is the ground truth output for the corresponding labeled training input or (ii) is derived from the ground truth output for the corresponding labeled training input.

Generally, and as will also be described in more detail below, each input in the processed unlabeled batch corresponds to a respective one of the unlabeled training inputs and the target output for the input either (i) is a guessed model output for the corresponding unlabeled training input or (ii) is derived from the guessed model output for the corresponding unlabeled training input. A guessed model output is one that is generated based on model outputs of the machine learning model, i.e., and not from any ground truth information provided as input to the system.

Generating the processed labeled batch and the processed unlabeled batch is described in more detail below with reference to FIG. 3.

The system trains the machine learning model on the processed labeled batch and the processed unlabeled batch to adjust the current values of the model parameters (step 208).

In particular, the system determines an update to the current values of the model parameters by computing a gradient of a self-supervised learning loss function that includes a labeled loss term and an unlabeled loss term. For example, the loss function can be a sum or a weighted sum of the labeled loss term and the unlabeled loss term.

The labeled loss term measures an error between, for each input in the processed labeled batch, (i) a model output generated for the input by the machine learning model in accordance with the current values of the parameters and (ii) the target output for the input in the processed labeled batch.

For example, the labeled loss term may be a cross-entropy loss between (i) the model output generated for the input by the machine learning model in accordance with the current values of the parameters and (ii) the target output for the input in the processed labeled batch.

The unlabeled loss term measures an error between, for each input in the processed unlabeled batch, (i) a model output generated for the input by the machine learning model in accordance with the current values of the parameters and (ii) the target output for the input in the processed unlabeled batch.

The unlabeled loss term may be the same loss, e.g., a cross-entropy loss, as the labeled loss term or a different type of machine learning loss. For example, when the labeled loss term is the cross-entropy loss, the unlabeled loss may be a squared L₂ loss between (i) a model output generated for the input by the machine learning model in accordance with the current values of the parameters and (ii) the target output for the input in the processed unlabeled batch. Using the squared L₂ loss may be beneficial because, unlike the cross-entropy loss, it is bounded and less sensitive to incorrect predictions.

More specifically, the system updates the current values of the model parameters by computing a gradient of the loss function with respect to the model parameters and on the processed labeled batch and the processed unlabeled batch and then updating the current values of the model parameters using the gradient. In particular, the system can apply an update rule, e.g., a learning rate, an Adam optimizer update rule, or an rmsProp update rule, to the gradient to generate an update and then apply, i.e., subtracting or adding, the update to the current values to determine updated values of the model parameters.

FIG. 3A is a flow diagram of an example process 300 for generating a processed labeled batch and a processed unlabeled batch. For convenience, the process 300 will be described as being performed by a system of one or more computers located in one or more locations. For example, a machine learning model training system, e.g., the machine learning model training system 100 of FIG. 1, appropriately programmed, can perform the process 300.

The system generates, from the labeled batch, an initial processed labeled batch (step 302).

In some implementations, the initial processed labeled batch is the same as the labeled batch, i.e., the system does not modify the labeled training input in the labeled batch.

In some other implementations, to generate the initial processed labeled batch, the system generates, from each labeled training input, a respective augmented labeled training input and associates the augmented labeled training input with the ground truth output for the labeled training input.

The data augmentation technique that the system uses to generate the augmented labeled training inputs can be any conventional augmentation technique that is appropriate for the types of inputs that the model is configured to process. Examples of data augmentation techniques are described below with reference to FIG. 3B.

Thus, in these implementations, the initial processed labeled batch includes a set of augmented labeled training inputs each associated with a corresponding ground truth output.

The system generates, from the unlabeled batch, an initial processed unlabeled batch (step 304).

The initial processed unlabeled batch includes, for each unlabeled training input in the unlabeled batch, K augmented unlabeled training inputs that are each associated with the same guessed model output. To ensure diversity, K is set to a fixed positive integer that is greater than one, e.g., two, four, or five. Thus, in place of each unlabeled training input in the unlabeled batch, the unlabeled batch includes multiple augmented unlabeled training inputs generated from the unlabeled training input.

FIG. 3B is a diagram showing the generation of an initial processed unlabeled batch.

In particular, to generate the augmented unlabeled training inputs for a given unlabeled training input 320, the system generates, from the unlabeled training input, K augmented unlabeled training inputs 330.

In particular, the system applies a data augmentation technique K times to the unlabeled training input to generate K augmented unlabeled training inputs 330 for the unlabeled training input 320.

The data augmentation technique can be any conventional augmentation technique that is appropriate for the types of inputs that the model is configured to process and that is stochastic, i.e., so that applying the same technique multiple times to the same input will generally result in multiple different augmented outputs.

As one example, when the inputs are images, the augmentation technique can be one that applies one or more of random horizontal flips, random vertical flips, random crops, or random rotations to each input image.

As another example, when the inputs are images, the augmentation technique can be one that adds a perturbation sampled from a distribution, e.g., a Gaussian distribution, to each input.

As another example, when the inputs are audio data, the augmentation technique can be one that adds a perturbation sampled from a distribution, e.g., a Gaussian distribution, to each input.

As another example, when the inputs include text data, the augmentation technique can be one that assigns a probability to each word in the in the text data, selects a fixed number of words in accordance with the probability, and then replaces each selected word with a different word, e.g., one sampled from a vocabulary of possible words.

The system then processes each of the K augmented unlabeled training inputs 330 using the machine learning model in accordance with current values of the parameters to generate a respective model output 340 for each augmented unlabeled training input, i.e., to generate K model outputs 340.

The system then generates, from the model outputs for the K augmented unlabeled training inputs, a single guessed model output and associates the guessed model output with each of the K augmented unlabeled training inputs 330, i.e., so that each augmented unlabeled training input 330 is associated with the same guessed model output.

More specifically, the system computes an average 350 of the model outputs for the K augmented unlabeled training inputs.

In some implementations, the system uses the average as the guessed model output.

In some other implementations, however, the system applies a sharpening function 360 to the average of the model outputs to reduce uncertainty in the average and then uses the output of the sharpening function as the guessed model output.

In particular, when the model output includes L probabilities, the output of the sharpening function for the i-th probability in the model output satisfies:

$${p}_{i}^{\frac{1}{T}} / {\sum }_{j = 1}^{L} {p}_{j}^{\frac{1}{T}} ,$$

where pᵢ is the value for the i-th probability in the average of the model outputs and T is a hyperparameter that is between zero and one, exclusive, e.g., .25, .5, or .75. By setting T between zero and one, the system sharpens the average probability distribution to reduce the entropy of the average probability distribution.

Thus, as can be seen from the above descriptions, the guessed model output for a given unlabeled training input is generated based on model outputs generated by the model for augmented versions of the training input, i.e., and not from any external ground truth data.

In some implementations, the system uses the initial processed labeled batch and the initial processed unlabeled batch as the final processed batches for the given iteration of training, i.e., as the batches on which the gradients described above with reference with FIG. 2 are computed.

In some other implementations, however, the system further processes the initial processed labeled batch, the initial processed unlabeled batch, or both to generate the final processed batches. For example, the system can perform this further processing to regularize the training process and improve the generalization of the model once trained.

In particular, in some implementations, the system generates the processed final batch by generating, for each particular augmented labeled input and associated ground truth output, a processed labeled input that is associated with a processed ground truth output (step 306).

In particular, for each given particular augmented labeled input, the system selects an input-output pair from a set that includes at least the augmented labeled inputs and associated ground truth outputs.

That is, in some cases, the set includes only the augmented labeled inputs and associated ground truth outputs.

In other cases, however, the set includes both (i) augmented labeled inputs and associated ground truth outputs and (ii) augmented unlabeled inputs and associated guessed outputs. Including both (i) and (ii) in the set can, in some cases, provide improved regularization for the training of the model.

For example, the system can select a pair by sampling from the set randomly without replacement, i.e., so that the same pair is not selected for more than one particular augmented labeled input.

The system then performs a convex combination of the augmented labeled input and the input in the selected pair to generate a processed input. To perform the convex combination, the system can sample a weight λ from a predetermined distribution and then compute a weighted sum between the augmented labeled input and the input in the selected pair, where the augmented labeled input is assigned the weight λ and the input in the selected pair is assigned the weight (1−λ).

The system also performs a convex combination of the ground truth output associated with the augmented labeled input and the output in the selected pair to generate a processed model output. To perform the convex combination, the system can compute a weighted sum between the ground truth output and the output in the selected pair, where the ground truth is assigned the weight λ and the output in the selected pair is assigned the weight (1−λ).

The system then associates the processed input with the processed output.

Instead of or in addition to performing step 306, in some implementations, the system generates, for each particular augmented unlabeled input and associated guessed output, a processed unlabeled input that is associated with a processed guessed output (step 308).

In particular, for each given particular augmented unlabeled input, the system selects an input-output pair from the set that includes (i) and (ii) above. For example, the system can select a pair by sampling from the set randomly without replacement, i.e., so that the same pair is not selected for more than one particular augmented labeled input. When step 306 is also performed, the system removes from the set any pairs that were sampled when generating the final processed labeled batch prior to sampling the pairs for the augmented unlabeled inputs.

The system then performs a convex combination of the augmented unlabeled input and the input in the selected pair to generate a processed input. To perform the convex combination, the system can sample a weight λ from a predetermined distribution and then compute the weighted sum as described above with reference to step 306.

The system also performs a convex combination of the guessed output associated with the augmented unlabeled input and the output in the selected pair to generate a processed model output, i.e., by computing the weighted sum using λ as described above.

The system then associates the processed input with the processed output.

In some implementations, instead of using a value directly sampled from the distribution as the λ value, the system can use a modified value as the λ value that's used in the convex combinations. In particular, when distribution is over a range of values between 0 and 1, exclusive or inclusive, the system can sample a value from the distribution and then set the λ value to the maximum of (i) the sample value and (ii) 1 minus the sampled value. This ensures that the processed particular augmented input, i.e., either labeled or unlabeled, is closer to the original augmented input than to the input that was sampled from the set.

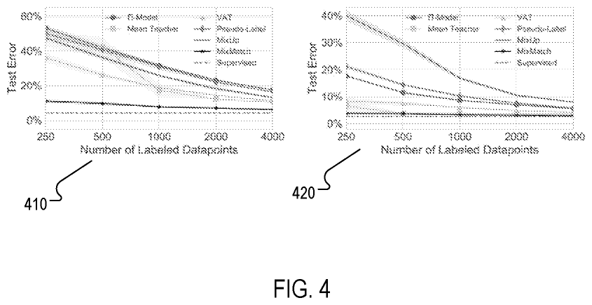

FIG. 4 shows the performance of the described techniques relative to other semi-supervised learning techniques.

In particular, FIG. 4 shows a comparison of the described techniques (“MixMatch”) with several competitive baselines on two data sets and using various numbers of labeled training inputs. In particular, chart 410 shows the performance of the described technique and a set of baselines on the CIFAR-10 data set while chart 420 shows the performance of the described technique and a set of baselines on the SVHN data set.

As can be seen from FIG. 4, the error rates of a trained model trained using the described techniques are consistently lower, i.e., better than the baselines, at different sizes of labeled data, i.e., the described technique consistently outperforms the baselines given different sizes of labeled data.

Thus, even compared to other semi-supervised learning techniques, i.e., other techniques that use both labeled and unlabeled data, the described techniques result in more effective model training.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, .e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method of training a machine learning model having a plurality of parameters to perform a machine learning task, wherein the machine learning model is configured to receive an input and to process the input in accordance with the parameters to generate a model output, the method comprising:
receiving an unlabeled batch comprising plurality of unlabeled training inputs;
receiving a labeled batch comprising a plurality of labeled training inputs and, for each labeled training input, a ground truth output that should be generated by the machine learning model by performing the particular machine learning task on the labeled training input;
generating, from the unlabeled batch and the labeled batch, a processed unlabeled batch and a processed labeled batch, the generating comprising:
for each unlabeled training input of the plurality of unlabeled training inputs:
generating, from the unlabeled training input, a plurality of augmented unlabeled training inputs;
processing each of the augmented unlabeled training inputs using the machine learning model in accordance with current values of the parameters to generate a respective model output for each augmented unlabeled training input;
generating, from the model outputs for the augmented unlabeled training inputs, a guessed model output; and
associating the guessed model output with each of the augmented unlabeled training inputs; and
training the machine learning model on the processed labeled batch and the processed unlabeled batch to adjust the current values of the parameters.

2. The method of claim 1, wherein the input to the machine learning model is an image and the model output is a probability distribution over a set of object classes.

3. The method of claim 1, wherein the input to the machine learning model is one or more video frames and the model output is a probability distribution over a set of object classes or a probability distribution over a set of topics.

4. The method of claim 1, wherein the input to the machine learning model is text and the model output is a probability distribution over a set of topics.

5. The method of claim 1, wherein the input to the machine learning model is an audio signal and the model output is a probability distribution over a set of natural language text.

6. The method of claim 1, wherein generating, from the model outputs for the augmented unlabeled training inputs, a guessed model output comprises:
computing an average of the model outputs for the augmented unlabeled training inputs.

7. The method of claim 6, wherein generating, from the model outputs for the augmented unlabeled training inputs, a guessed model output further comprises:
applying a sharpening function to the average of the model outputs to reduce uncertainty in the average.

8. The method of claim 1, wherein generating, from the unlabeled batch and the labeled batch, a processed unlabeled batch and a processed labeled batch further comprises:
for each labeled training input of the plurality of labeled training inputs:
generating, from the labeled training input, an augmented labeled training input; and
associating the augmented labeled training input with the ground truth output for the labeled training input.

9. The method of claim 8, wherein generating, from the unlabeled batch and the labeled batch, a processed unlabeled batch and a processed labeled batch further comprises:
generating, for each particular augmented labeled input and associated ground truth output, a processed labeled input that is associated with a processed ground truth output, comprising:
selecting an input—output pair from the set of (i) augmented labeled inputs and associated ground truth outputs and (ii) augmented unlabeled inputs and associated guessed outputs;
performing a convex combination of the augmented labeled input and the input in the input selected pair to generate a processed input;
performing a convex combination of the ground truth output associated with the augmented labeled input and the output in the selected pair to generate a processed output; and
associating the processed input with the processed output.

10. The method of claim 8, wherein generating, from the unlabeled batch and the labeled batch, a processed unlabeled batch and a processed labeled batch further comprises:
generating, for each particular augmented unlabeled input and associated guessed output, a processed unlabeled input that is associated with a processed guessed output, comprising:
selecting an input-output pair from the set of (i) augmented labeled inputs and associated ground truth outputs and (ii) augmented unlabeled inputs and associated guessed outputs;
performing a convex combination of the augmented unlabeled input and the input in the selected pair to generate a processed input;
performing a convex combination of the guessed output associated with the augmented unlabeled input and the output in the selected pair to generate a processed output; and
associating the processed input with the processed output.

11. (canceled)

12. One or more non-transitory computer-readable storage media storing instructions that when executed by one or more computers cause the one more computers to perform operations for training a machine learning model having a plurality of parameters to perform a machine learning task, wherein the machine learning model is configured to receive an input and to process the input in accordance with the parameters to generate a model output, the operations comprising:
receiving an unlabeled batch comprising plurality of unlabeled training inputs;
receiving a labeled batch comprising a plurality of labeled training inputs and, for each labeled training input, a ground truth output that should be generated by the machine learning model by performing the particular machine learning task on the labeled training input
generating, from the unlabeled batch and the labeled batch, a processed unlabeled batch and a processed labeled batch, the generating comprising:
for each unlabeled training input of the plurality of unlabeled training inputs:
generating, from the unlabeled training input, a plurality of augmented unlabeled training inputs;
processing each of the augmented unlabeled training inputs using the machine learning model in accordance with current values of the parameters to generate a respective model output for each augmented unlabeled training input
generating, from the model outputs for the augmented unlabeled training inputs, a guessed model output and
associating the guessed model output with each of the augmented unlabeled training inputs; and
training the machine learning model on the processed labeled batch and the processed unlabeled batch to adjust the current values of the parameters.

13. A system comprising one or more computers and one or more storage devices storing instructions that when executed by one or more computers cause the one or more computers to perform operations for training a machine learning model having a plurality of parameters to perform a machine learning task, wherein the machine learning model is configured to receive an input and to process the input in accordance with the parameters to generate a model output, the operations comprising:
receiving an unlabeled batch comprising plurality of unlabeled training inputs;
receiving a labeled batch comprising a plurality of labeled training inputs and, for each labeled training input, a ground truth output that should be generated by the machine learning model by performing the particular machine learning task on the labeled training input;
generating, from the unlabeled batch and the labeled batch, a processed unlabeled batch and a processed labeled batch, the generating comprising:
for each unlabeled training input of the plurality of unlabeled training inputs:
generating, from the unlabeled training input, a plurality of augmented unlabeled training inputs;
processing each of the augmented unlabeled training inputs using the machine learning model in accordance with current values of the parameters to generate a respective model output for each augmented unlabeled training input;
generating, from the model outputs for the augmented unlabeled training inputs, a guessed model output; and
associating the guessed model output with each of the augmented unlabeled training inputs; and
training the machine learning model on the processed labeled batch and the processed unlabeled batch to adjust the current values of the parameters.

14. The system of claim 13, wherein generating, from the model outputs for the augmented unlabeled training inputs, a guessed model output comprises:
computing an average of the model outputs for the augmented unlabeled training inputs.

15. The system of claim 14, wherein generating, from the model outputs for the augmented unlabeled training inputs, a guessed model output further comprises:
applying a sharpening function to the average of the model outputs to reduce uncertainty in the average.

16. The system of claim 13, wherein generating, from the unlabeled batch and the labeled batch, a processed unlabeled batch and a processed labeled batch further comprises:
for each labeled training input of the plurality of labeled training inputs:
generating, from the labeled training input, an augmented labeled training input; and
associating the augmented labeled training input with the ground truth output for the labeled training input.

17. The system of claim 16, wherein generating, from the unlabeled batch and the labeled batch, a processed unlabeled batch and a processed labeled batch further comprises:
generating, for each particular augmented labeled input and associated ground truth output, a processed labeled input that is associated with a processed ground truth output, comprising:
selecting an input-output pair from the set of (i) augmented labeled inputs and associated ground truth outputs and (ii) augmented unlabeled inputs and associated guessed outputs;
performing a convex combination of the augmented labeled input and the input in the input selected pair to generate a processed input;
performing a convex combination of the ground truth output associated with the augmented labeled input and the output in the selected pair to generate a processed output; and
associating the processed input with the processed output.

18. The system of claim 16, wherein generating, from the unlabeled batch and the labeled batch, a processed unlabeled batch and a processed labeled batch further comprises:
generating, for each particular augmented unlabeled input and associated guessed output, a processed unlabeled input that is associated with a processed guessed output, comprising:
selecting an input-output pair from the set of (i) augmented labeled inputs and associated ground truth outputs and (ii) augmented unlabeled inputs and associated guessed outputs;
performing a convex combination of the augmented unlabeled input and the input in the selected pair to generate a processed input;
performing a convex combination of the guessed output associated with the augmented unlabeled input and the output in the selected pair to generate a processed output; and
associating the processed input with the processed output.

19. The system of claim 13, wherein the input to the machine learning model is an image and the model output is a probability distribution over a set of object classes.

20. The system of claim 13, wherein the input to the machine learning model is one or more video frames and the model output is a probability distribution over a set of object classes or a probability distribution over a set of topics.

21. The system of claim 13, wherein the input to the machine learning model is an audio signal and the model output is a probability distribution over a set of natural language text.
